(19) United States
(12) Patent Application Publication
(10) Pub. No.: US 2001/0049617 A1
(43) Pub. Date: Dec. 6, 2001

(54) Web-driven calendar updating system

(76) Inventors: Richard W. Berenson, Newton, MA (US); David Sklar, Cambridge, MA (US); Adam Trachtenberg, Cambridge, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/792,823

(22) Filed: Feb. 23, 2001

Related U.S. Application Data
(60) Provisional application No. 60/184,669, filed on Feb. 24, 2000.

(51) Int. Cl. G06F 17/60

(52) U.S. Cl. 705/8

(57) ABSTRACT

An event scheduling system which allows a user to request reminders of upcoming events over the Internet. The user may request to be reminded about a specific event or he may request to be reminded of events that meet a certain criteria. The reminders automatically update the user's electronic calendar if requested by the user. The reminders may also notify the user of the event by a variety of different media. The reminders may also automatically update the user's calendar as a result of changed data event.

### RELATED APPLICATION

This application claims the benefit under 35 U.S.C. 119 of the filing date of the provisional application with Ser. No. 60/184,669, filed Feb. 24, 2000.

### FIELD

This invention relates to computer-based calendaring systems.

### BACKGROUND

The Internet provides access to schedules that display pre-planned events. These events include meetings, shows, classes, television programs, lectures, seminars or other happenings that may be of interest to the general public or a selected population. These schedules of events are typically posted on the Internet available at a website for a given time period and venue and are intended for viewing by a visitor to the website.

Some of the Internet-provided schedules also provide a service of sending an email to a user who has requested to be reminded of the occurrence of a pre-selected event. Users may also request notification of items or events that meet a certain criteria. Programs known as web agents are available to constantly search through the web to notify a user, usually by email, of items that meets the user's criteria.

However, these notification systems are limited because the intended recipient must be at his/her computer/web service in order to receive and acknowledge the reminder.

### SUMMARY

Disclosed below is a method of sending an event message for a scheduled event comprising a client system capable of sending an event message request including a set of event criteria to a server system capable of receiving the request, matching the event criteria with event data and sending at least one event message containing event information for an event whose data matches the event criteria to a recipient system. The server system may store the request for further processing.

In one embodiment, a system for sending event messages may generate different types of messages (such as e-mails, instant messaging messages, spoken audio, pager messages, calendar entries, and so on) using different media (such as the internet, wireless transmission, the telephone system, and so on) for different purposes (such as notifying about a new event or a change in an existing event, reminding of an event already known about, or instructing a devise attached to a receiving client to take some action). The messages may have a command piece which may cause a device associated with the receiving client to take some action (such as placing an entry in a calendar database, may operate an audio/visual device (including without limitation, display, decoding, and recording devices), may allow a transaction (such as a purchase) to be completed, or may allow a receiving client or its user to reply to the message.

### BRIEF DESCRIPTION OF THE DRAWINGS

The discussion below will be better understood by referencing the following figures:

FIG. 1 shows a typical connection of a user computer to a target site;

FIG. 2 shows a schedule of TV programs;

FIG. 3 is a top level diagram of a web based calendaring system;

FIG. 4 is a diagram of one method of generating calendar schedules according to the present invention;

FIG. 5 shows a typical email event message and calendar update; and

FIG. 6 shows an alternative embodiment of the event message processing system.

### DETAILED DESCRIPTION

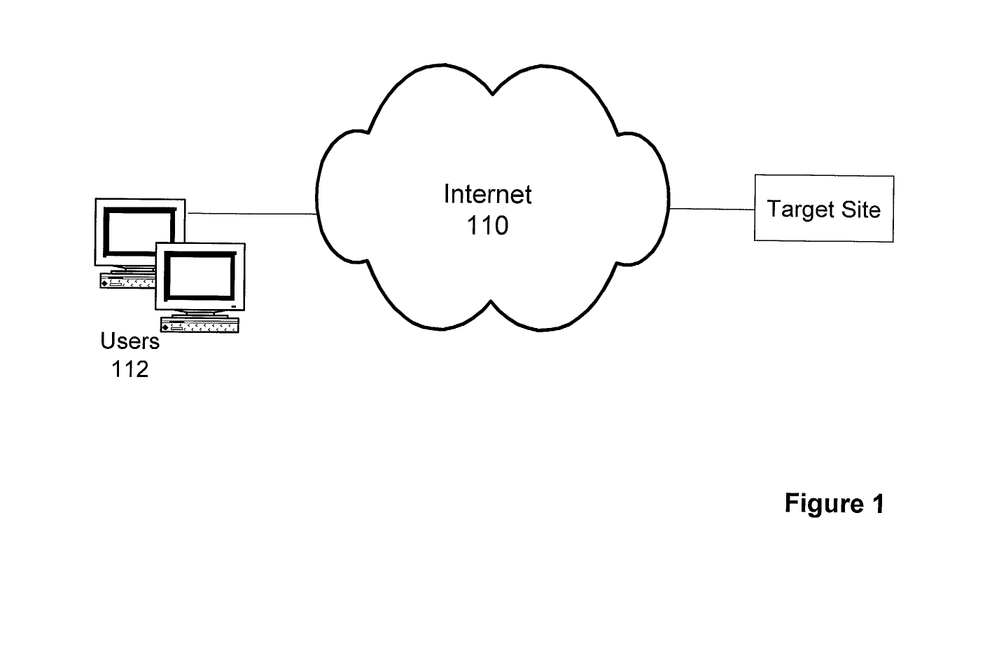

Users may select from myriad sites that are viewable over the Internet or via other computer networks using a computer, portable device or other method. The user accesses the target sites over the Internet (or an intranet) and information is relayed from the site to the user as generally shown in FIG. 1. Often the sites are interactive, taking input from the user as well as outputting information. Many services are available to users over a network such as purchasing goods, paying bills, or participating in group discussions.

Two example systems available to users over a network are computerized personal calendaring and scheduling systems. Examples of these range from desktop based Microsoft® Outlook to ubiquitous personal digital assistants. Further, many Internet portals, for example, Yahoo! and Lycos, provide calendars that a user may access from anywhere access to the World Wide Web is available. These systems and devices allow users to receive email and schedule appointments and reminders for later recall, display, or printing. In the case of the Internet-based calendars, these reminders may be delivered by email. They also allow individuals to schedule group meetings with a set of specifically named individuals.

However, these personal calendaring systems are limited because they are personal: they do not draw information from publicly-posted event schedules, nor do they facilitate meetings among a group of individuals defined solely on their common interests. Further, reminders from this system consist solely of emails or pop-up windows displayed on the PC where the calendar is active.

A further limitation of these calendaring systems is evident when event data changes. If a user creates an appointment in a calendaring system it is that user's responsibility to make sure that the event data is current and has not changed. If the event data does change (such as a time/date change, location change, or content change) the user is not notified and will therefore have an appointment on his/her calendar with incorrect data.

A system for requesting, creating and updating event messages which may include calendar entries from an event schedule accessible by a computer network (such as the Internet) is described below. A user accesses the schedule and requests an event message to be sent to him/her based on a set of criteria determined by the user. The event message may be in several different forms, including, without limitation, calendar entries, pages, faxes or wireless updates. The event schedule system displays events to the user and may insert an event into the user's calendar either automatically or at the user's request. The system may also perform other scheduling functions.

The following describes a particular embodiment of an event schedule, the presentation of television program information in a grid. The system is equally applicable to other events and venues such as, but not limited to, public or private events, artistic events, sporting events, campus events, on-line events, broadcast events, etc. The explanation with respect to television event listings is used for ease of explanation and is not intended to be limiting. The calendaring system may be used with any manner of event.

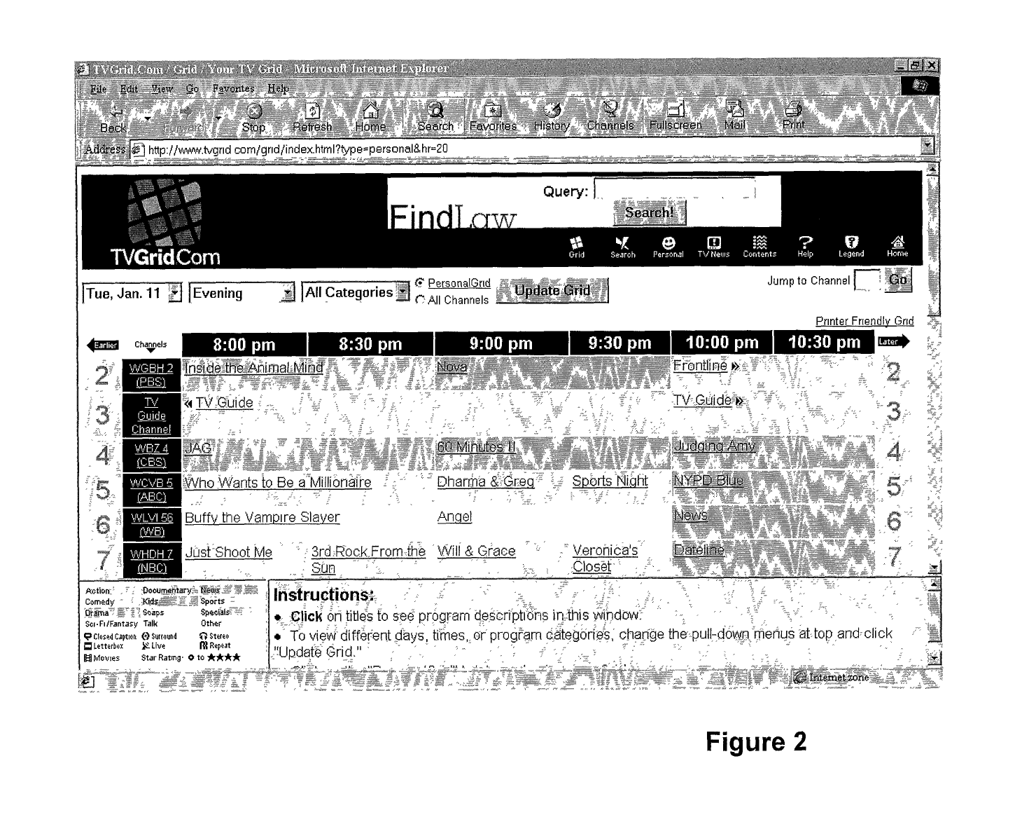

The service through which users may take advantage of the calendaring system is an event listing service. For example, a user visits a television program listing web site, enters personal data, and is able to view a schedule of events or programs that are available to the user at different times. Television programming varies geographically, and by service provider. Therefore, when the user accesses the site, and enters his/her zip code and television service provider, the user has access to a listing, usually in a grid form, of the programs that are to be broadcast in that particular area by the user's service provider. FIG. 2 shows an example of what a user might see when accessing the TVGrid.com web site of TV Grid, Inc. of Boston, Mass. Each program is listed, showing the channel and the time it will be broadcast. The programs may be color-coded to indicate a particular category of program and the title of each show provides a hypertext link which the user may follow to obtain more information about the program. Each program is listed inside a block which occupies the space in between the marked times during which the show will be broadcast.

For example, referring to FIG. 2, channel 7 (WHDH 7 NBC) will show five different programs from 8 PM until 11 PM. The first four of those shows are half-hour long programs and the last is a full hour.

The user may interact with the site to obtain program information for different channels, different television providers, different days, and different categories of viewing.

The user may request that the calendaring system remind the user when a certain program is to be broadcast or even to schedule the broadcast of the program into the user's electronic calendar. The user may also request that the calendaring system notify the viewer when programs matching certain user-selected event criteria are scheduled to be broadcast. The event criteria selected by the user may include one or more selection categories. For example, the user may select criteria based on a particular actor, a particular theme (such as science fiction programs), director, or other criteria that define a class of event that the user is interested in. Event criteria may also be combined to create a more specific event (e.g., science fiction films directed by Steven Spielberg).

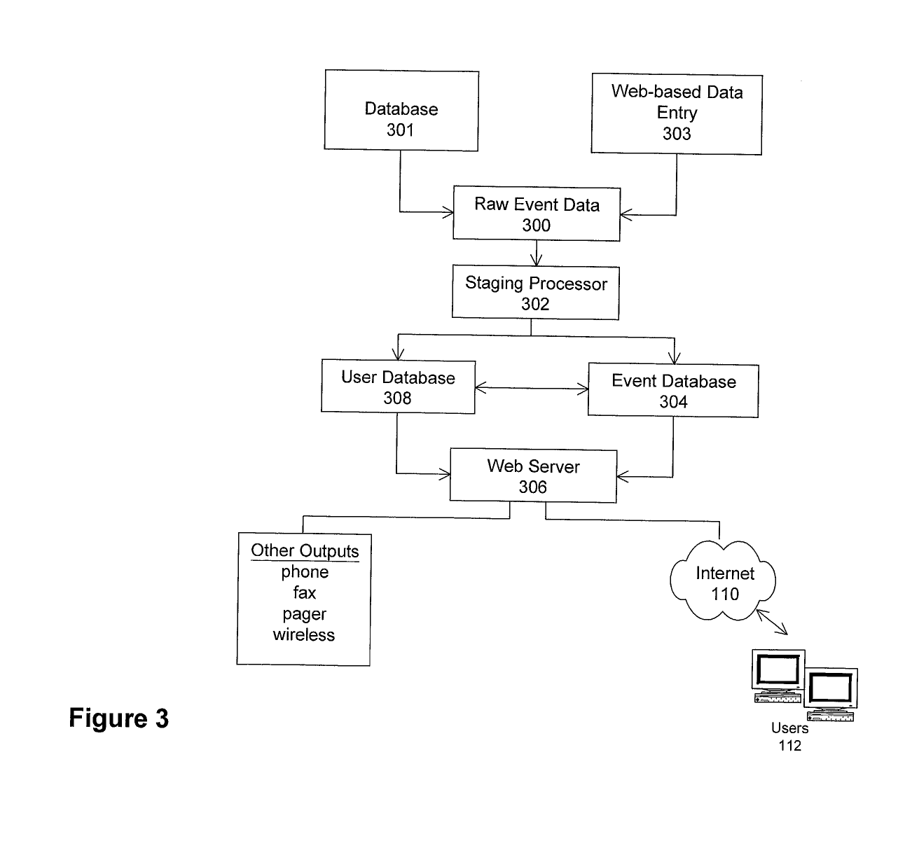

One exemplary embodiment of the web based calendaring system is shown in FIG. 3. Raw event data 300, collected from either a data source database 301 or through a web-based event information entry system 303, is sent to a staging processor 302. The staging processor 302 then formats and analyzes the event data as necessary into a desired scheme so that it may be retrieved. The formatted data is then sent to an event database 304 where it may be accessed by a web server 306. A user 112 connects to the web server 306 over the Internet 110. The user 112 interacts with the web server 306 and views the event data. User information is stored in a user database 308 that interacts with the web server 306. User profiles, calendar requests, notification requests, and other information are stored in the user database 308. At appropriate times, the web server 306 sends the appointments or notifications to the user 112 over the Internet 110 or through an external output 314 which connects with other media, for example: telephone, fax machine, pager, wireless device, personal digital assistant, calendar event scheduling protocols, etc. The system may operate in a client server model or in other models such as a peer to peer environment with no centralized server. The peer to peer model may combine machines to form a generating system from which requesting systems would receive event messages.

The calendaring system is capable of providing a number of customizable options to the user. These options may include potential reminder time, preferred reminder media, type of calendaring system or other information, which will enhance a user's interaction with the system. In order to facilitate interaction with the calendar updating system, users are encouraged to provide this particular information to the system so that the system may customize the options accordingly. The system may then leave an amount of data such as a “cookie” on the user's computer so that the user is easily identifiable by the system the next time the user makes use of the system. The system may then identify the user and then reference the user database 308 that stores the preferences and information for each user.

There are two ways a user may request event messages. The first way is by requesting a reminder for a particular program. This type of reminder may be requested by following a link directly from the public events schedule, or by entering the particular event in a search request query. The second way a user may request an event message is by entering an event criteria request. To do this, the user enters a search query screen (by following the appropriate link on the calendaring system web site) and enters a set of criteria, which match the kinds of programs the user wishes, as described above. The resulting event message requests from either method are stored in the user database 308. A program run by the staging processor 302 regularly searches for any unfulfilled event message requests and sends them at the appropriate time. A program also identifies new event message requests to be executed.

The event schedule may offer links for each event listed which allow the user to automatically request a reminder for that particular event.

The criteria requests are handled by the system as described below. A user describes a search for events based on the user's criteria. That search is then generated and put into a list of personal searches stored by the user database 108. Those personal searches are used to generate reminders for events stored in the system. The reminders are then compiled and stored together. At the appropriate time as defined by the calendaring system (or by the user's preferences) the reminder is sent to the user in an event message. The event message is either sent by email, telephone, or by any other system capable media.

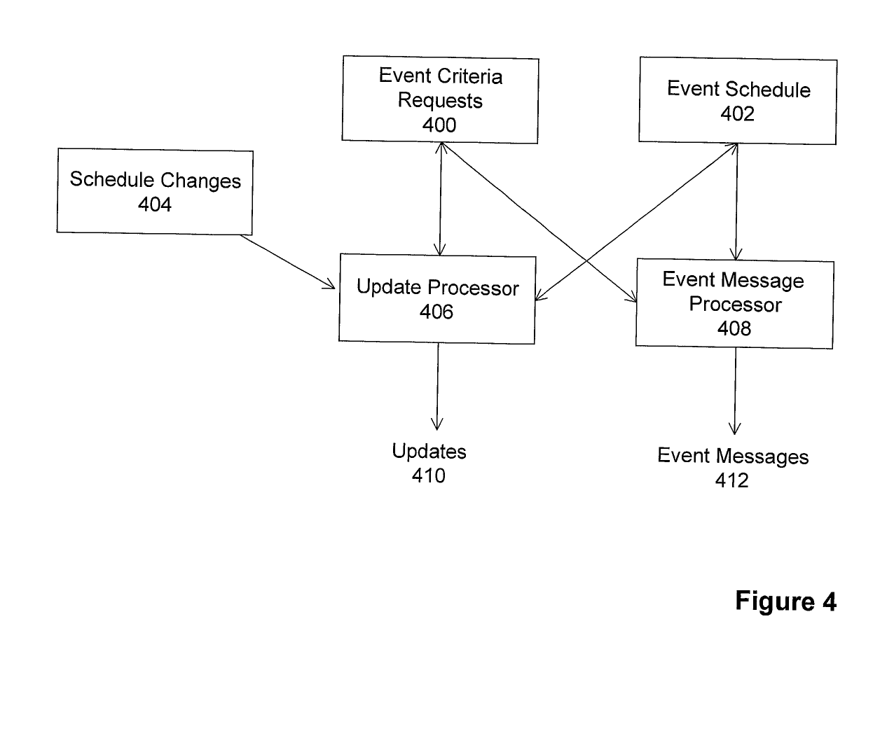

The preferred method of generating event messages based on a set of criteria entered by the user is shown in FIG. 4. Event criteria requests entered by users are stored together 400. The events are also stored in a master schedule 402. The event message processor 408 checks the criteria requests against the event schedule and generates event messages 412 that will be sent to users. Sometime the event schedule 402 changes due to alterations in event data (such as a program time change, subject change or deletion). These schedule changes 404 may come from the program originator or broadcaster. Schedule changes 404 are handled by an update processor 406. The update processor 406 takes the new schedule information and checks it against the event criteria requests 400. The update processor also may check new schedule information against reminders requested for a particular event. If any users have requested notification about events that have been modified, or otherwise affected by other modified events, the update processor generates updates 410 that will be sent to users.

In one embodiment, the calendaring system may transmit different types of event messages. One type is a notification, where the system sends a message the user informing him/her of an newly scheduled or changed upcoming event which meets certain criteria. A second type of message is a reminder, where the system sends a message to the user at a time proximate to the occurrence of the event to bring the event to the forefront of the user's mind. The third type of message is an event schedule entry where the system puts an entry into the user's electronic personal calendar system indicating the time and location of the selected event. The personal calendar system holds the event data so the user may view it in the context of an overall personal schedule. The fourth type is a message with instructions or a command piece attached. An event message may be of any one or more of these types.

The event schedule entry sends an entry to the user's electronic calendar indicating the time and location of the event. There are two types of calendar entries that the user may request from the system. The first type allows the user to accept or decline the calendar entry when it is sent to the user's electronic calendar and the second allows the system to automatically schedule the entry without the user needing to acknowledge the scheduling of the entry after it is requested. The advantages of the accept/decline option include the user's ability to cancel the entry before it is entered into his calendar, and gives the user another reminder of the upcoming event. The advantages of automatically scheduling the entry include speed and no time lost by the user acknowledging the calendar entry.

The user may indicate what kind of calendar the user has so the system may send the event schedule entry in the proper format. The user may also choose by what media an event message is to be sent (fax, voice, wireless, etc.). When the calendaring system sends the event message it may also send a command piece which causes the email/calendaring system to create an appointment or event item in the calendar.

The command piece may be a client-side script in an HTML-enabled or other type of active content message. For example, the message may have some VBScript or Javascript that instantiates ActiveX objects on the client or uses some other interface exposed by the email/calendaring system to pass the necessary information.

The command piece may also be a MIME (or other attachment scheme) attachment to the email message that the email/calendaring system recognizes and interprets. This attachment may be a client-side script or some other format, possibly proprietary to a specific calendar system. vCalendar is a standard data format of this type recognized by, among others, Microsoft calendaring products including Outlook.

The command piece may cause one or more reminders to be scheduled, updated, or deleted. The scheduled reminders may each contain a token that uniquely identifies that reminder. This token may be used for updating or deleting that specific reminder in future-sent command pieces, based on updates to the event data.

The command piece may also contain information that controls how the reminder is handled by the user's email/calendaring system, e.g., how soon before the event the system is to remind the user, how many times to remind the user, etc.

Event schedule entries may be sent via email, Internet, telephone, pager, or other wire based or wireless device depending on the preferences of the user and his type of electronic calendar.

The event schedule entries may also have features that give the user flexibility when scheduling events. For example, if the user is busy during an event that the calendaring system tries to schedule, the user may indicate to the calendaring system to attempt to schedule the next occurrence of the event, or, alternatively, the next occurrence of the event where the user has no other events scheduled. The user may also indicate to the calendaring system that he wishes to schedule other individuals for the same event. The calendaring system may then automatically send calendar entries to those individuals depending on whether or not the calendaring system has the proper formatting information, or may contact them via different mechanisms to notify them of the event. If authorized to by the user, the calendaring system may also, without prompting by the user, schedule alternate event entries if a conflict with the initial entry exists.

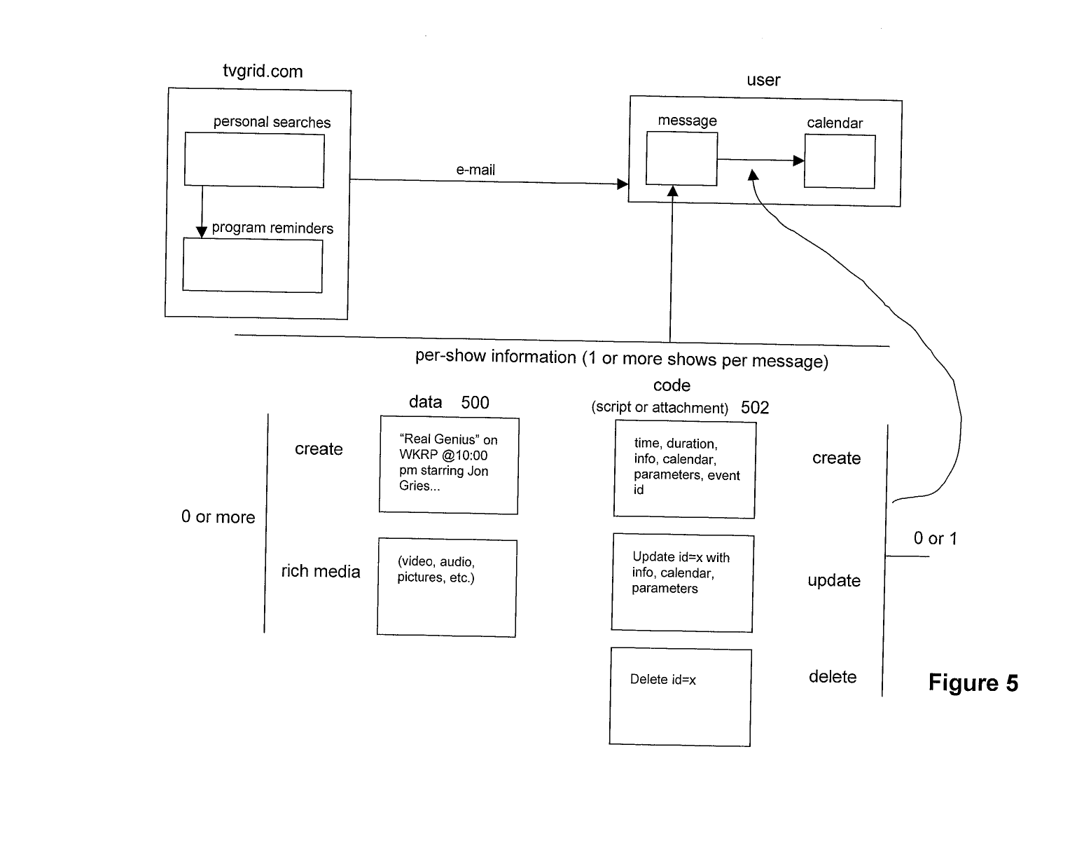

The system may also provide reminder support for various personal calendaring systems. Microsoft Outlook is an example of a personal calendar system which supports reminders of the nature of reminders contemplated here. A personal calendar could request that the system send a reminder of a personal event to the calendar owner or to others. FIG. 5 shows one format for an email event message. The data 500 contains user viewable event data. The event message may also include attachments such as video data, audio data, pictures, links to other events or web pages, etc. These attachments may contain a variety of information. They may be specific to the event (such as concert details, notes on actors, etc.) or may be general in nature (such as a review of the user's events scheduled through the system). The data 500 may contain no user viewable information or may include a variety of such information depending on the system configuration and the user's preferences when the reminder was requested. The code 502 may contain the appointment or event to be inserted into the user's calendar program. If the email is only for reminder purposes then no code may be necessary. If, however, the user's calendar is to be changed, the code may perform one or more of the following: create a new entry in the calendar, update an existing entry, or delete an existing entry. The actual commands used to perform this operation may depend on the calendar of the user.

If the data for the event changes before the event occurs, but after the calendar entry or a reminder has been sent, the system may automatically update the calendar entry and send a new reminder with the corrected data. The correction to the calendar entry, like the original calendar entry may be either an accept/decline entry, which allows the user to decide whether to incorporate the correction into his calendar, or the correction may be automatic, such that no action is required on the user's part to correct the data in the calendar entry. The calendaring system may also delete the previous reminder, if unread by the user or if it has already been read, the calendaring system may send an update 410 to the user notifying the user of the corrected information.

Furthermore, the user may indicate that he/she wishes to receive the event message (either original or corrections) in a form other than email or calendar. The user may prefer to receive it via fax, voice mail, pager, any other medium or combination thereof. The calendaring system may send the event message in the appropriate form at the appropriate time.

The option to be reminded via an alternate media may be available by replying to the reminder, but may also be activated while interacting with the main system. The user may, in his/her preferences, notify the system to check the user's personal calendar system for availability before determining the media over which to send the event message at the requested time. For example, if the user is at home, a phone message may be preferable; if at work, an email; if on the road, a wireless message, etc.

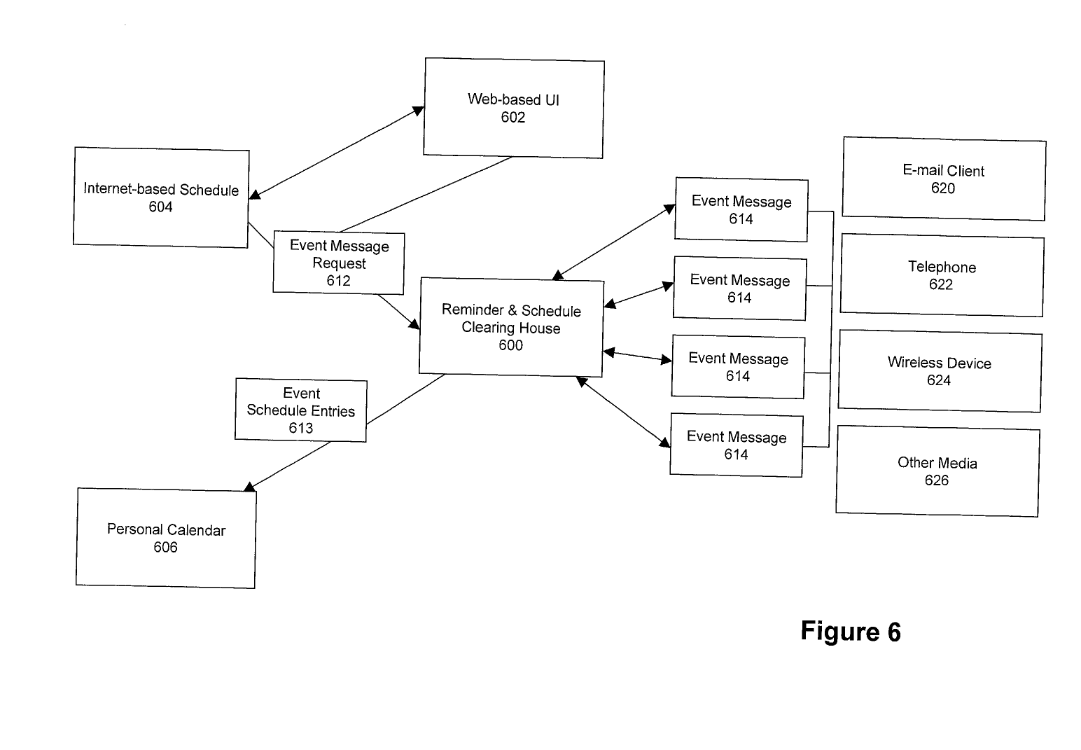

An alternate embodiment for the reminder and calendar event scheduler is shown in FIG. 6. In this embodiment, one central system, the clearinghouse server 600, handles all event message requests 612 and also processes the event messages 614. A user interacts with the web-based user interface 602 to access the Internet based schedule 604. After reviewing the schedule, the user sends an event message request 612 to the central processing system 600. The system may then send event schedule entries 613 to the user's personal calendar 606 if desired by the user. The system also sends the event message 614 over the appropriate medium as requested by the user. These messages may be sent to an email client 620, to a telephone 622, to a wireless device 624, or to another media receptacle 626. The event message may be sent to a different location from the requesting system.

The system may send event messages along any of one or more different media. The user selects, either in the setting of initial preferences, or when the user requests the event message, how the user prefers to receive event messages. The messages may come via phone message over a telephone line, a facsimile over a facsimile machine, a message over a pager, by email, to a personal digital assistant (PDA), directly to other wireless devices, etc. For each of the different media options the user may choose, the system will format the message accordingly and will send it to the user.

These messages may include other information in addition to the reminder for the specific event. For example, for a reminder regarding a television program, the reminder may include content related to the program. This content may be advertisements, previews of related shows or other multimedia content. In the case of phone or voice mail the reminder may include a pre-recorded or pre-generated (or assembled) voice message which may be in the voice of one of the actors of the particular show. A facsimile reminder may contain a picture of the actors of the program. In the case of email, other items may be included, for example, audio clips, video clips, trailers for upcoming programs, or links to related sites.

Many computers have the capability to show television programs. The event message may include a command script for activating an audio visual device such as a television or a television receiver on a computer when the program is scheduled to be broadcast, or alternatively, to activate a device to record the program at the scheduled time.

The event messages may also include extra features such as a snooze feature that allows the user to indicate to the system that he wishes to receive another event message regarding the program in the future. Furthermore, the user may indicate that the system should forward the message to a different telephone number, email, wireless device, pager, etc. that the user requests. This could be used to forward the reminder to a friend, or to send the reminder to a location the user finds more desirable. These features are easily incorporated into the different media. For example, for a telephone reminder, the user may key in (using the touch pad) certain menu-driven commands in order to activate these features. For a pager, the user may press certain two-way buttons, and so on, for the different reminder media.

Another reply option may allow the user to purchase tickets for the event. This would obviously apply to events that require tickets, but may also be used for other events that require an advanced purchase such as pay-per-view television programs. Another reply option may allow the user to purchase other goods or services related to the event such as memorabilia, transportation services, etc. Another reply option may allow the user to indicate to the system that the system should activate a recording device to record a television/radio/online or other event at the user's request.

Other reply options may allow the user to cancel pending reminders, or to prevent future reminders from being sent to a particular address or device. For example, a user may block future unwanted telephone reminders by entering a particular telephone keypad code upon receiving an unwanted reminder call.

Another reply option may allow the user to respond with feedback about the event being scheduled. The system may use that feedback to compile “ratings” data or to notify the user if he/she requests to be reminded for an event that he/she has already attended/watched. Hence, a reminder might be sent either before or after an event.

In one embodiment, the system may require authorization before a particular media is used for delivering event messages. For example, in the case of telephone reminders, the system may require the user to adequately prove his/her identity before a telephone reminder could be sent. Methods of identification may include, without limitation, having the user provide a digital ID, or a phone number that is linked through a public database to the individual's name, and/or replying to a communication initiated by the system.

Having thus described at least one illustrative embodiment of the present invention, various alterations, modifications, and improvements will readily occur to those skilled in the art. Such alterations, modifications, and improvements are intended to be within the spirit and scope of the invention. Accordingly, the foregoing description is by way of example only and is not intended as limiting.

What is claimed is:

1. A method of sending an event message for a scheduled event, the method comprising:
under control of a requesting system:
sending an event message request to a generating system, the request including a set of event criteria;
under control of the generating system:
receiving the event message request,
matching the event criteria with event data,
sending at least one event message to a recipient system, the event message containing event information for an event whose data matches the event criteria.

2. The method of claim 1, wherein the generating system stores the event message request for subsequent processing.

3. The method of claim 1, wherein the event message contains instructions to cause one or more of:
the operation of an audio-visual or recording device;
the sending of data to a calendar module; and
the completion of a transaction.

4. The method of claim 1, further comprising:
under control of the recipient system:
receiving the event message; and
updating a calendar module to incorporate the event message.

5. The method of claim 4, wherein the calendar module is updated without intervention by a user.

6. The method of claim 4, wherein the calendar module is updated subsequent to approval being granted by a user to perform the update to the calendar module.

7. The method of any one of claims 1-6, wherein the reminder and the event message are sent through the Internet.

8. The method of any one of claims 1-6, wherein the requesting system and generating system communicate with one another through a wireless connection.

9. The method of any one of claims 1-6, wherein the generating system and recipient system communicate with one another through a wireless connection.

10. The method as recited in claim 1, further comprising:
under control of the recipient system:
receiving the event message;
accessing a calendar module to determine if a conflict exists between the event message and a pre-existing event in the calendar module; and
when a conflict has been determined:
sending a second request to the generating system for a new event message for an alternate occurrence of the event.

11. The method of claim 1, further comprising:
under control of the recipient system:
sending a forwarding request to the generating system for a second event message to be sent to a different device capable of receiving reminders.

12. The method of claim 11, wherein the generating system stores the second event message request for subsequent processing.

13. The method of claim 11, wherein the second event message contains instructions to cause one or more of:
the operation of an audio-visual or recording device;
the sending of data to a calendar module; and
the completion of a transaction.

14. The method of claim 11, further comprising:
under control of the different device:
receiving the second event message; and
updating a calendar module to incorporate the event message.

15. The method as recited in claim 11, wherein the different device resides on a second recipient system.

16. The method as recited in claim 11, wherein the different device resides on the recipient system.

17. The method as recited in claim 11, wherein the different device resides on the generating system.

18. The method of claim 1, wherein the recipient system is the requesting system.

19. A computer readable medium storing executable instructions of a computer program to be executed by a computer system, the executable instructions comprising:
A) program code to be executed on a generating system to determine if the generating system receives a event message request including a set of event criteria from a requesting system;
B) program code to be executed on the generating system to send an event message from the generating system to a recipient system if the event criteria matches event data; and
C) program code to be executed on the recipient system to accept and handle the event message.

20. The computer readable medium of claim 19, the executable instructions further comprising:
D) program code to be executed on the recipient system to respond to the generating system after receiving the event message.

21. The computer readable medium of claim 19, wherein the program code to be executed on the recipient system includes instructions to cause one or more of:
the operation of an audio-visual or recording device;
the sending of data to a calander module; and
the completion of a transaction.

22. An apparatus for setting an appointment on a requesting system for a first scheduled event, the apparatus comprising:
a generating system including:
a processor responsive to an input device and a sequence of program instructions which sends an event message request to a generating system, the event message request including a set of event criteria;
a requesting system including:
a processor responsive to a sequence of program instructions which:
receives the event message request,
matches the event criteria with event data, and
sends an event message to the generating system, the event message containing event information for an event whose event data matches the event criteria.

23. A generating system for sending event messages to a requesting system, the generating system comprising:
a processor responsive to a sequence of program instructions which:
receives an event message request which includes event criteria,
matches the event criteria with event data,
sends an event message to a client system, the event message containing event information for an event whose event data matches the event criteria.

24. A requesting system for receiving event messages from a generating system, the requesting system comprising:
a processor responsive to an input device and a sequence of program instructions which:
receives an event schedule;
sends a event message request to a generating system, the event message request including a set of event criteria;
receives an event message from the generating system, the event message containing event information for an event whose event data matches the event criteria.

25. A method of setting an appointment reminder for a scheduled event on a requesting system, the method comprising:
by a generating system:
receiving event data;
receiving a query containing a set of event criteria from a user;
matching the event criteria to the event data; and
sending an event message to the user based on the results of the matching.

26. A method of setting an appointment reminder for a scheduled event on a requesting system, the method comprising:
by the requesting system:
sending a query containing a set of event criteria to a generating system;
sending calendar data to the generating system;
requesting an event message from the generating system; and
receiving the event message from the generating system.

27. A method of sending an event message for a scheduled event to a user, the method comprising:
by the user:
sending a event message request to a reminder processor, the event message request including a set of event criteria;
by the reminder processor:
receiving the event message request,
matching the event criteria with event data,
sending at least one event message to the user, the event message containing event information for an event whose data matches the event criteria.

28. The method of claim 27, further comprising:
by the reminder processor:
receiving updated event data,
matching the updated event data with the received event criteria,
sending at least one event message to the user containing updated event data wherein the data of at least one event matches the event criteria.

29. The method of claim 27, wherein the event message request contains instructions to cause one or more of:
the operation of an audio-visual or recording device;
the sending of data to a calander module; and
the completion of a transaction.

30. The method of claims 27 or 28, further comprising:
by the user:
receiving the event message; and
updating a calendar module to incorporate the event message.

31. The method of claim 30, wherein the calendar module is updated without intervention by the user.

32. The method of claim 31, wherein the calendar module is updated subsequent to the user granting approval to perform the updating of the calendar module.

33. The method of claims 27 or 28 further comprising:
by the user:
receiving the event message;
accessing a calendar module to determine if a conflict exists between the event message and a pre-existing event in the calendar module; and
when a conflict has been determined:
sending a second request to the reminder processor for a new event message for a next occurrence of the at least one event.

34. The method of claims 27, 28 or 29, further comprising:
by the user:
sending a forwarding request to the reminder processor for a second event message to be sent to a different device capable of receiving reminders.

35. The method of claim 34, wherein the reminder processor stores the second event message request for subsequent processing.

36. The method of claim 34, wherein the second event message contains instructions to cause one or more of:
the operation of an audio-visual or recording device;
the sending of data to a calendar module; and
the completion of a transaction.

37. The method of claim 34, further comprising:
under control of the different device:
receiving the second event message; and
updating a calendar module to incorporate the event message.

38. The method of claims 27, 28 or 29, wherein the event message contains event data unrelated to scheduling.
